(19) United States
(12) Patent Application Publication
(10) Pub. No.: US 2026/0195729 A1
(43) Pub. Date: Jul. 9, 2026

(54) LOCKABLE TOP-OPENING FREEZER

(71) Applicant: SOCIÉTÉ DES PRODUITS NESTLÉ S.A., Vevey (CH)

(72) Inventors: Krzysztof OLECHNO, Blonay (CH); Philippe BOUCHARDY, Vevey (CH)

(21) Appl. No.: 19/128,411

(22) PCT Filed: Nov. 9, 2023
(86) PCT No.: PCT/EP2023/081261

§ 371 Date: May 8, 2025

(30) Foreign Application Priority Data
Nov. 11, 2022 (EP) 22206971.8

(51) Int. Cl. G06Q 20/18; G07C 9/00

(52) U.S. Cl. CPC G06Q 20/18; G07C 9/00309; G07C 9/00896; G07C 2009/00769; G07C 2209/08

(57) ABSTRACT

A method for dispensing one or more frozen food products from a lockable top-opening freezer, wherein the freezer defines a volume accessible by a door of the freezer, the volume contains the one or more frozen food products, and the freezer comprises an electronically controlled lock configured to be controlled to lock and unlock the door thereby preventing and granting access to the volume and the one or more frozen food products, the method comprising the steps of: identifying the freezer with a user mobile device; communicating with the electronically controlled lock to unlock the door of the freezer; identifying on the user mobile device one or more frozen food products and initiating a payment process; and optionally communicating with the electronically controlled lock to lock the door of the freezer.

### FIELD AND BACKGROUND

The present techniques relate to dispensing one or more frozen food products from a lockable top-opening freezer. More particularly, but not exclusively, the present techniques relate to communicating with an electronically controlled lock of the freezer to unlock and lock the freezer.

Freezers operate so as to reduce the temperature of an internal volume. In commercial environments, such freezers generally contain one or more items or products, for example frozen food products such as ice cream, which may be selected by a user, removed from the freezer, and subsequently purchased.

Lockable freezers comprise one or more locks that may be electronically controlled to unlock or lock a door of the freezer, thereby controlling access to the internal volume and the one or more products contained therein. Thus, in a commercial environment, access to the products contained within the freezer can be controlled, for example dependent on the satisfaction of one or more conditions.

However, as recognised by the inventors of the present techniques, existing methods for controlling a lockable top-opening freezer can lack efficiency and flexibility, and may be overly complex and therefore cost-prohibitive.

At least certain embodiments of the present disclosure address one or more of these problems as set out above.

### SUMMARY

Particular aspects and embodiments are set out in the appended claims.

Viewed from a first aspect, there is provided a method for dispensing one or more frozen food products from a lockable top-opening freezer, wherein the freezer defines a volume accessible by a door of the freezer, the volume contains the one or more frozen food products, and the freezer comprises an electronically controlled lock configured to be controlled to lock and unlock the door thereby preventing and granting access to the volume and the one or more frozen food products, the method comprising the steps of: identifying the freezer with a user mobile device; communicating with the electronically controlled lock to unlock the door of the freezer; identifying on the user mobile device one or more frozen food products and initiating a payment process; and optionally communicating with the electronically controlled lock to lock the door of the freezer.

Thus, the present approach allows for the dispensing of frozen food products from a freezer in an efficient and cost-effective manner. In particular, the present approach utilises a top-opening freezer combined with an electronically controlled lock.

Advantageously the top-opening freezer may be a standard commercially available chest freezer of the type manufactured, for example by Hiron. Such a standard freezer may be retrofitted or otherwise modified with an electronically controlled lock module as described herein. The module advantageously comprises the necessary locking mechanics to prevent the door of the freezer opening and the associated communication and electronics to receive control signals from the mobile device as described herein. In this way, costs are significantly reduced compared to examples where dedicated vending machine freezers are used.

In an example, a user may be near to a top-opening freezer, which may be located in a retail environment, hotel, or other commercial or public environment, and the user mobile device identifies the freezer, and the freezer is caused to unlock by scanning QR code or other technology. This opens a mobile application on user's phone. The user may then open the unlocked freezer and select one or more frozen food products from the freezer, for example ice cream. The user then scans the barcode(s) of the frozen food product(s) that they have selected with their mobile phone's camera, and pay with mobile application for the selected frozen food product(s). Once paid, the electronically controlled lock may then be controlled to lock the freezer. Thus, the present approach provides a method for dispensing frozen food products from a lockable top-opening freezer in an efficient and cost-effective manner.

In some examples, the method comprises communicating with the electronically controlled lock to lock the door of the freezer. In other words, in these examples, this step is not optional.

In some examples, identifying the freezer with the user mobile device is based on receiving user input indicating an identifier of the freezer. In other words, the user interacts with the user mobile device to provide user input that indicates an identifier of the freezer near to the user. Thus, the freezer is identified in an efficient manner.

While the present disclosure refers to a top-opening freezer, or chest freezer, it will be appreciated that the present techniques apply equally to other forms of freezers, or indeed other apparatuses that define an internal volume accessible by a door.

In some examples, the freezer is initially in a locked state, i.e. the freezer is in a locked state by default. When the freezer is identified with the user mobile device, the electronically controlled lock is controlled to unlock the door of the freezer. Thus, in some examples, communicating with the electronically controlled lock to unlock the door of the freezer is based on identifying the freezer with the user mobile device.

In some examples, receiving user input indicating the identifier of the freezer comprises receiving, from a camera of the user mobile device, a digital image of the identifier of the freezer. In this way, the user is able to facilitate the efficient identification of the freezer. For example, the user may use a camera of their mobile device to scan or otherwise capture a photograph of an identifier of the freezer. The method may further comprise comparing the digital image of the identifier with stored identifiers of freezers to determine the freezer identified by the identifier. Thus, the freezer near to the user can be determined efficiently.

In some examples, the identifier of the freezer is a one-dimensional or two-dimensional barcode, but not limited to this technology. For example, the identifier may be a unique identifier, such as a unique linear barcode or QR code. Thus, the freezer can be efficiently identified by the user capturing an image of the barcode located on the freezer or using other technology (e.g. NFC (Near Field Communication)).

In some examples, receiving the user input indicating the identifier of the freezer comprises receiving, from an input device of the user mobile device, the identifier of the freezer. In other words, the user may type in or otherwise input the identifier of the freezer. For example, the user may recognise a code or string located on the freezer and may type the code or string into their mobile device to identify the nearby freezer. In this way, the freezer can be identified on the user mobile device in a resource efficient manner.

In some examples, identifying the freezer with the user mobile device is based on determining a location of the user mobile device. In some examples, the method further comprises comparing the determined location of the user mobile device to stored locations of one or more freezers. In other words, the freezer near to a user mobile device is automatically detected. The user mobile device may be GPS-enabled, internet-connected, and/or cellular-connected and may be configured to determine its own location. The determined location may then be compared to stored locations of one or more freezers, and the most proximal freezer to the determined location may be identified as the freezer. Thus, in these examples, the freezer is identified without user input of the freezer identifier.

In some examples, communicating with the electronically controlled lock to unlock the door of the freezer comprises generating and sending an instruction to the electronically controlled lock to cause the electronically controlled lock to unlock the door of the freezer. For example, a server in communication with the user mobile device and the electronically controlled lock may generate the instruction and send the instruction to the electronically controlled lock, which may be configured to receive the instruction and, based on the instruction, unlock the door of the freezer. In other words, the generating and sending of the instruction causes the electronically controlled lock to unlock the door of the freezer. Unlocking the door allows the user to open the door and select one of more frozen food products contained therein. In some examples, the instruction is sent from the device, in other examples, the instruction is sent from a server and the lock is network-connected.

In some examples, identifying on the user mobile device one or more frozen food products comprises receiving, from the user mobile device, one or more identifiers of the one or more frozen food products. In this way, the selected frozen food product is efficiently identified on the user device. The user may open the unlocked door of the freezer, select a frozen food product, and enter on their mobile device an identifier of the selected product. In some examples, the user may type in the name of the selected product.

In some examples, receiving, from the user mobile device, the one or more identifiers of the one or more frozen food products comprises receiving, from a camera of the user mobile device, one or more digital images of the one or more identifiers of the one or more frozen food products. Thus, in these examples, the user scans or takes a picture with their mobile device of the frozen food product selected from the freezer. In some examples, the one or more identifiers of the one or more frozen food products may be one or more barcodes. In other words, each frozen food product is labelled with a barcode, and the user scans the barcode with their mobile device to identify on their mobile device the selected product. The digital image may be compared to stored information of frozen food products and their associated identifiers to determine the frozen food product identified in the digital image.

In some examples, initiating the payment process comprises displaying, on the user mobile device, a payment portal for receiving user payment input associated with the one or more frozen food products. For example, the user mobile device may display a payment webpage that identifies the frozen food products scanned by the user, and accepts payment for the frozen food products. The user may therefore pay for their selected products using their mobile device.

In some examples, the method further comprises after identifying on the user mobile device one or more frozen food products, updating information indicating the frozen food products contained within the freezer. Thus, in these examples, the information acts as an inventory of the products that are contained within the freezer. The information may be stored in a data store hosted on a server accessible by the device. Accordingly, stock levels of items can be tracked automatically and in an efficient manner, without requiring manual stock keeping. In some examples, the method further comprises generating an alert based on updating the information. The alert may be transmitted to a further device different from the user mobile device. The further device may in some examples be a server external from the user device. Accordingly, transactions are notified and stock levels may be efficiently monitored.

In some examples, the method further comprises before communicating with the electronically controlled lock to unlock the door of the freezer and based on identifying the freezer, obtaining information indicating the contents of the freezer and displaying the information indicating the contents of the freezer on the user mobile device. In other words, an inventory of the freezer is shown on the user mobile device before unlocking the freezer. Accordingly, the user can efficiently determine the stock levels and the items within the nearby freezer, so as to make a decision about a possible purchase while the freezer remains locked, thereby increasing security.

In some examples, the information further indicates one or more items not contained within the volume of the freezer, the method further comprising, responsive to a user input, providing information associated with a second freezer which contains the one more items not contained in the freezer. In these such examples, the information may indicate to the user that an item is out of stock in the most proximal freezer, but responsive to a user input, for example a request to locate the item, information associated with a second freezer which does have the item in stock is provided to the user. In this way, while the item may be out of stock in the freezer proximal to the user, the user may nevertheless obtain the product from an alternate freezer.

In some examples, the information associated with the second freezer comprises a location of the second freezer. For example, the user may, after requesting the out-of-stock item, be presented with information that indicates the item is in stock in a second freezer and the location of that second freezer.

In some examples, the method further comprises based on identifying the freezer on the user mobile device, generating and sending a notification to a further device, wherein the notification comprises information indicating that the freezer has been identified on the user mobile device. For example the further device may be a device of a second user different from the user, for example a shopkeeper or other staff member associated with the environment in which the freezer is located, for example a hotel, cinema, etc. As such, the second user may be notified that the freezer has been identified on the user's mobile device. This alerts the second user that a transaction is likely to take place, and thus may cause them to observe the transaction. Accordingly, the integrity of the transaction and security of the freezer is increased in a cost-efficient manner.

In some examples, the method further comprises based on communicating with the electronically controlled lock to unlock the door of the freezer, generating and sending a notification to a further device, wherein the notification comprises information indicating that the freezer has been unlocked. As before, the notification alerts the second user that the freezer is now unlocked and the second user may then observe the transaction. Accordingly, the integrity of the transaction and security of the freezer is increased.

In some examples, the method further comprises based on identifying on the user mobile device the one or more frozen food products, generating and sending a notification to a further device, wherein the notification comprises information indicating that the one or more frozen food products have been identified. This may enable the second user, or member of staff, to intervene if the user has selected a certain item on their device but removes a different item from the freezer. Accordingly, the integrity of the transaction is increased in a cost-efficient manner and without complex sensor arrays to determine the exact item taken from the freezer.

In some examples, the information indicates the number of identified one or more frozen food products. Indicating the number of identified items allows for an easier determination as to whether the user removed the same number of items from the freezer as they have identified on their device. Continuing with the member of staff as the second user example, the member of staff may be notified of the number of items identified by the user. For example, the member of staff may be notified that the user has selected a single ice cream, but see that the user has actually taken three ice creams. Accordingly, fraudulent behaviour may be more readily identified and subsequently prevented.

In some examples, the information comprises one or more digital images representing the identified one or more frozen food products. As mentioned, the further device may be operated by a member of staff physically located near the freezer, for example in the same commercial establishment. The member of staff may therefore receive the notification and the selected items may be more readily recognised as the user selects the items from the freezer. For example, the member of staff may be notified that a chocolate ice cream was identified, but see that the user has actually taken a fruit ice cream. Thus, fraudulent behaviour may be more readily identified.

In some examples, the method further comprises determining that a pre-determined time period starting from the communicating with the electronically controlled lock to unlock the door of the freezer has elapsed, and based on determining that the pre-determined time period has elapsed, communicating with the electronically controlled lock to lock the door of the freezer. For example, the freezer may be identified and the lock of the freezer may be controlled to unlock the door. A countdown may then start which upon reaching a pre-determined amount of time, for example 60 seconds, then causes a second instruction to be sent to the lock to cause the door to be locked. In providing time-limited access to the freezer, the security of the freezer is increased in an efficient manner, and the integrity of the purchase is increased. For example, a time-limited window reduces the possibility of fraudulent behaviour being conducted.

In some examples, the top-opening freezer is a chest freezer and the door is a slidable door. For example, the top-opening freezer may be a standard commercial chest freezer. In some examples, the slidable door comprises a first slidable door and a second slidable door, each defining respective portions of the volume accessible by the respective slidable door in use, wherein the lock is configured to be selectively controlled to selectively unlock the first slidable door and/or the second slidable door.

In some examples, the door may be a slidable door that slides relative to the freezer so as to allow access to the internal volume of the freezer. The present techniques may be particularly suited for use with a standard chest freezer with one or more slidable doors and an electronically operated lock. In this way, a standard freezer may be combined with an electronic lock, such as a ‘smart’ lock or IoT lock, to convert the freezer and lock into a controllable freezer using the present techniques. Indeed, standard freezers may be retrofitted with an electronic lock in combination with the present techniques. This represents a cost-effective solution to providing increased convenience and security, for example compared to commercial dedicated vending machines.

In some examples, the slidable door comprises a first slidable door and a second slidable door, each defining respective portions of the internal volume of the freezer/freezer accessible by the respective slidable door in use. In some examples, the lock is configured to be selectively controlled to selectively unlock the first slidable door or the second slidable door. For example, the lock may comprise processing circuitry configured to exchange data and/or receive instructions to lock or unlock the door, for example by actuation of a locking mechanism such as a pin or bolt. In this way, the transaction is more secure. Indeed, rather than granting the user access to the entire volume of the freezer/freezer, the accessible volume is limited, and so the possibility for fraudulent behaviour is reduced. The lock may be configured to selectively unlock either slidable door through actuation of a pin or bolt or similar. Alternatively, the lock may comprise two separate locking portions each configured to lock and unlock the respective slidable doors.

In some examples, the slidable door comprises a first slidable door and a second slidable door, each defining respective portions of the internal volume of the freezer/freezer accessible by the respective slidable door in use. In some examples, the lock is configured to be selectively controlled to selectively unlock the first slidable door or the second slidable door. For example, the lock may comprise processing circuitry configured to exchange data and/or receive instructions to lock or unlock the door, for example by actuation of a locking mechanism such as a pin or bolt. In this way, the transaction is more secure. Indeed, rather than granting the user access to the entire volume of the freezer/freezer, the accessible volume is limited, and so the possibility for fraudulent behaviour is reduced. The lock may be configured to selectively unlock either slidable door through actuation of a pin or bolt or similar. Alternatively, the lock may comprise two separate locking portions each configured to lock and unlock the respective slidable doors.

In some examples, the freezer does not contain sensors configured to determine the items taken by the user from the freezer. In these examples, the security of the transaction may be increased through other techniques described herein, thereby allowing for the use of standard freezers and without the need for complex sensors. Examples sensors that may not be present in the freezer include cameras, weight sensors, and/or capacitive sensors.

In a second aspect, there is provided a system comprising one or more processor configured to perform the methods of the present techniques.

In a third aspect, there is provided a computer-readable medium comprising instructions which, when executed by a computer, cause the computer to perform the methods of the present techniques.

Other aspects will also become apparent upon review of the present disclosure, in particular upon review of the Brief Description of the Drawings, Detailed Description and Claims sections.

### BRIEF DESCRIPTION OF THE DRAWINGS

Examples of the disclosure will now be described, by way of example only, with reference to the accompanying drawings in which:

FIG. 1: schematically illustrates a freezer according to the present techniques.

FIG. 2: schematically illustrates a method for controlling a lockable freezer according to the present techniques.

FIG. 3: schematically illustrates a further freezer according to the present techniques.

FIG. 4: schematically illustrates a further method for controlling a lockable freezer according to the present techniques.

FIG. 5: schematically illustrates a further method for controlling a lockable freezer according to the present techniques.

While the disclosure is susceptible to various modifications and alternative forms, specific example approaches are shown by way of example in the drawings and are herein described in detail. It should be understood however that the drawings and detailed description attached hereto are not intended to limit the disclosure to the particular form disclosed but rather the disclosure is to cover all modifications, equivalents and alternatives falling within the spirit and scope of the claimed invention.

It will be recognised that the features of the above-described examples of the disclosure can conveniently and interchangeably be used in any suitable combination.

### DETAILED DESCRIPTION

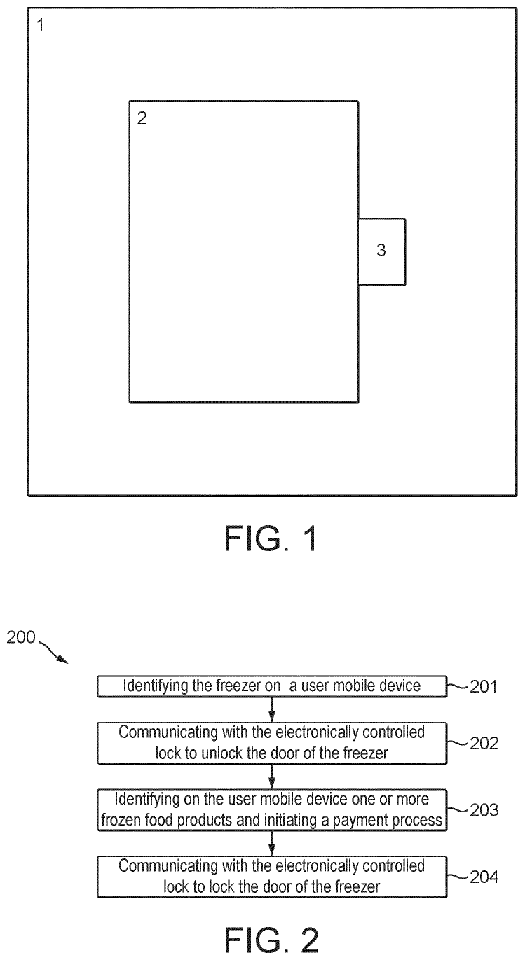

FIG. 1 schematically illustrates a freezer 1. The freezer 1 may in some embodiments be controlled using the present techniques and/or may dispense one or more frozen food products according to the present techniques. The freezer 1 defines an internal volume accessible by a door 2 of the freezer 1. The freezer 1 also comprises an electronically controlled lock 3 configured to be controlled to lock and unlock the door 2, thereby preventing and granting access to the volume of the freezer 1.

The freezer 1 is a top-opening freezer, and it will be appreciated that the internal volume may store one or more frozen food products, for example ice cream. The door 2 may be hingedly or slidably connected to the freezer 1, such that when the lock is in an unlocked state, a user may open the door 2 of the freezer 1 to access the items within the freezer 1. In a default configuration, the freezer 1 is in a locked state such that access to the items within the freezer 1 is prevented.

The lock 3 is an electronically controlled lock configured to be controlled based on received instructions. For example, the lock 3 may be a ‘smart’ lock, an internet-connected lock or an IoT lock. In this way, the lock 3 may comprise processing circuitry configured to exchange data with other devices and systems over the internet or other communication networks. For example, the lock 3 may be configured to exchange data with a server, the server being configured to send lock and unlock instructions to the lock, and the lock being configured to actuate a locking mechanism based on the received instruction.

As mentioned, the lock 3 comprises a locking mechanism that is engageable with the door so as to lock and unlock the door. Such a locking mechanism comprise a pin and an actuator to actuate movement of the pin. The door may have a corresponding engagement portion configured to engage the pin of the lock when actuated. The locking mechanism may alternatively comprise one or more electromagnets. It will be appreciated that a variety of locking mechanisms may be used which will depend on the implementation.

FIG. 2 schematically illustrates a method 200 for dispensing one or more frozen food products from a lockable top-opening freezer, for example the lockable freezer 1 of FIG. 1. In some embodiments, the method 200 is a method for controlling the lockable freezer by controlling the lock of the lockable freezer. Controlling the lockable freezer may mean unlocking the lockable freezer.

At step 201, the freezer is identified with a user mobile device.

At step 202, the electronically controlled lock is communicated with to unlock the door of the freezer. In some examples, step 202 is based on identifying the freezer in step 201.

At step 203, one or more frozen food products are identified on the mobile user device and a payment process is initiated.

In some examples, step 204 is optional, in other examples step 204 is not optional. At step 204, the electronically controlled lock is communicated with to lock the door of the freezer.

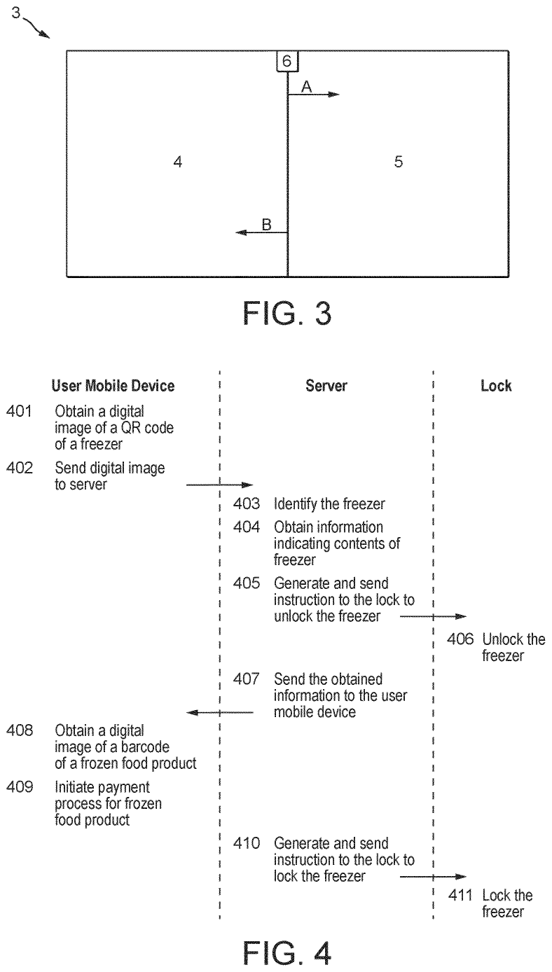

FIG. 3 schematically illustrates a freezer 3 that may in some embodiments be controlled using the present techniques. The freezer 3 may be a chest freezer, for example a standard commercial chest freezer. The freezer 3 comprises a first slidable door 4 and a second slidable door 5. The first and second slidable doors 4, 5 are configured to slide relative to the freezer 3 in the direction indicated by arrows A, B. In particular, the first slidable door 4 is slidable relative to the freezer 3 in the direction of arrow A. In use, a user may slide the first slidable door 4 so as to access the portion of the internal volume of the freezer 3 accessible by the first slidable door 4. The second slidable door 5 is slidable relative to the freezer in the direction of arrow B. In use, the user may slide the second slidable door 5 so as to access the portion of the internal volume of the freezer 3 accessible by the second slidable door 5.

The freezer 3 also includes an electronically controlled lock 6. The lock 6 is configured to engage portions of the first and second slidable doors 4, 5 so as to prevent sliding movement of the doors 4, 5, thereby locking the doors and preventing access to the internal volume of the freezer 3. The lock 6 is also configured to disengage the doors 4, 5, i.e. to unlock, so as to allow sliding movement of the doors 4, 5 thereby unlocking the doors and granting access to the internal volume of the freezer 3.

In some examples, the lock 6 is configured to unlock both the first slidable door 4 and the second slidable door 5 at substantially the same time, i.e. in the same unlocking action.

In other examples, the lock 6 is configured to selectively unlock either the first slidable door 4 or the second slidable door 5. This selective unlocking may increase the security of the freezer 3. Indeed, in some examples the method comprises receiving an indication from the user of a frozen food product that they intend to identify with their mobile device. Thus, if the user provides an indication of the frozen food product they intend to select from the freezer before the freezer is unlocked, the location of the frozen food product within the freezer 3 may be determined. For example, whether the selected frozen food product is accessible via the first slidable door 4 or the second slidable door 5. This may be determined based on stored position information of the contents of the freezer. An instruction may then be generated that causes the lock to unlock either the first slidable door 4 or the second slidable door 5, depending on the determined location of the frozen food product. For example, the user may select on their device a chocolate ice cream that is located behind the first slidable door 4. The lock 6 may therefore be controlled so as to unlock the first slidable door 4 and not the second slidable door 5.

In some examples, a barrier is present in the freezer 3 to physically divide the internal volume into a first volume portion accessible by the first slidable door 4 and a second volume portion accessible by the second slidable door 5. This barrier may act so as to prevent a user from accessing the second volume when the first slidable door 4 is open, and vice versa. This may further increase the security of the freezer and the integrity of the transaction. In some examples, the barrier may extend substantially to the level of the slidable doors 4, 5.

In some examples, the freezer 3 (and/or the freezer 1 from FIG. 1) may comprise one or more sensors, for example weight sensors, capacitive sensors, magnetic sensors etc. The one or more sensors may be configured to generate information, and an alert may be generated based on this information. For example, when the sensor is a weight sensor, an alert may be generated if a detected change in weight does not correspond to the weight of items selected by the user. In this example, the user may have selected a single item, or an item with a certain weight, but then has taken from the freezer 3 multiple items or a different item that has a different weight. Similarly, when the sensor is a capacitive sensor, the sensed information may indicate that the user is reaching into/accessing a portion of the freezer 3 that does not correspond to a known location of the item the user has selected. Further, when the sensor is a magnetic sensor, the sensed information may indicate that force is being applied to the doors, further indicating that there is an ongoing attempt at unauthorised entry of the freezer.

In some examples, the freezer 3 comprises audio generating or light generating circuitry, and the alert may be a sound or a light. In other examples, the alert may be a notification transmitted to an external system or device. For example, the alert may be sent to a device operated by a shopkeeper in the same shop as the freezer 3, notifying the shopkeeper as to the sensed information or that unauthorised behaviour has taken place or is ongoing. This notification therefore increases the security of the device, in that the notification acts as an alarm.

FIG. 4 schematically illustrates a method 400 associated with the user mobile device, a server, and the electronically controlled lock according to some examples of the present techniques. The server is an external server network-connected to both the device and the lock of the freezer/freezer. The dotted vertical lines indicate a time axis.

At 401, the user mobile device obtains a digital image of a QR code of a freezer. As mentioned, the user of the device may approach a freezer in a retail or other public environment and scan a QR code located on the freezer with their mobile device, for example a camera of the mobile device. The user mobile device is a network-connected mobile device, for example a telephone or tablet.

At 402, the user mobile device sends the digital image of the QR code to the server network-connected to the user mobile device.

At 403, the server identifies the freezer based on the digital image. For example, the server may process the digital image to determine the QR code, and compare the determined QR code with one or more QR codes stored in a database or memory, each associated a freezer. The freezer with a QR code that matches the QR code determined from the digital image is identified as the freezer, i.e. as the freezer scanned by the user and thus the freezer the user intends to interact with.

At 404, the server obtains information indicating contents of the freezer. This information may include stored inventory information that indicates the contents of the freezer, for example the frozen food products currently in stock and contained within the freezer.

At 405, the server generates and sends an instruction to the electronically controlled lock to unlock the freezer. In some examples, step 405 is based on the identification of the freezer 403. For example, the server may store in memory or a database an association between one or more freezers and one or more electronic locks. In particular, the server may maintain a database of QR codes identifying a freezer in association with an electronically controlled lock for controlling that freezer. In this way, the server may determine which lock must be controlled to control the freezer identified in the QR code of the digital image from the user mobile device.

At 406, based on receiving the instruction from the server, the electronically controlled lock unlocks the freezer. For example, the electronically controlled lock controls a locking mechanism to disengage the door of the freezer.

At 407, the server sends the obtained information (from step 404) to the user mobile device. For example, the server sends the inventory information indicating the contents of the freezer to the user mobile device. In some examples, steps 404 and 407 are optional, and in some examples method 400 does not include steps 404 and 407.

At step 408, the user mobile device obtains a digital image of a barcode of a frozen food product. For example, once the freezer is unlocked, the user opens the freezer and chooses a frozen food product they wish to purchase. To do this, the user may scan a barcode of the selected frozen food product with their mobile device, for example by taking a digital image of the barcode. Step 408 may further comprise determining the barcode in the digital image (using image analysis techniques) and comparing the determined barcode to one or more stored barcodes of one of more frozen food products to determine the frozen food product identified by the barcode in the image.

It will be appreciated that this determination may be carried out on the user mobile device, on the server, or a combination. For example, the obtained digital image from step 408 may be sent to the server, and the server may determine the frozen food product identified by the barcode by comparing the barcode to stored associations of barcodes and frozen food products, and send information to the user mobile device to initiate the payment process. The information may include information relating to a price of the frozen food product retrieved from a database.

At step 409, a payment process is initiated for the frozen food product. Initiating the payment process may comprise displaying, on the user mobile device, a payment portal for receiving user input associated with payment of the frozen food product. In some examples, the user is taken to an internet payment page on the device and may enter financial credentials to purchase the frozen food product. In particular, the user may scan a barcode of a chocolate ice cream, and then be presented with a payment portal for paying for that chocolate ice cream. The user may then provide user input associated with the payment, for example credit card information, or device-based payment such as Apple Pay or Android Pay.

Upon successful payment or completion of the payment process, information indicating that the payment was successful may be generated and sent to the server. Based on this, or otherwise, step 410 may be carried out. At step 410, the server may generate and send a further instruction to the electronically controlled lock to lock the freezer. In some examples, this lock instruction is sent after a predetermined time period has elapsed after the first unlock instruction was sent, thereby providing time-limited access to the freezer. In some examples, the predetermined time period starts when the payment process is initiated, giving the user a period of time in which to successfully complete payment for the frozen food product.

At step 411, based on receiving the instruction from the server, the lock locks the freezer. For example, the instruction causes the lock mechanism to engage with the door thus locking the freezer.

The device may receive user input in a variety of ways. For example, the user may select one or more items that are being displayed by the device. In other words, when the freezer is a freezer and the items are ice creams, the user may be presented with a list of ice creams that are in stock in the nearby freezer, and select one or more items they wish to purchase. The user input may therefore comprise a selection of one or more items that are being displayed on the device.

The user may then complete a payment process to purchase the one or more selected items. For example, the user may be taken to an internet payment page on the device and may enter financial credentials to purchase the one or more items. Thus, the received user input may further comprise user input associated with a payment process of the selected one or more items. In some examples, information indicating that the payment process has been successfully completed is generated by the device.

At 408, the received user input (for example the user selection of the one or more items) is sent to the server. As above, the received user input sent to the server may comprise user input associated with a payment process of the selected one or more items. Additionally or alternatively, information indicating that the payment process has been successfully completed is sent from the device to the server.

At 409, the server determines whether a condition associated with the user input is satisfied. For example, the condition may be that a payment process associated with the selected one or more items has been successfully completed. The server may determine this from the received information indicating that the payment process has been successfully completed. For example, the payment process may be successfully completed by the user on the device, and the device may send the selection of the items to the server with information that indicates that the items have been successfully purchased. In some examples, the server determines that a condition associated with the user input is satisfied.

Additionally or alternatively, the server may determine that this condition has been satisfied based on the user input associated with the payment process of the selected one or more items, or based on the received user input itself. For example, the device may send the selection to the server, whereupon the server independently verifies that the selected items have been successfully purchased.

At 410, the server generates and sends an instruction to the lock of the freezer to unlock the door.

At 411, the lock unlocks the door of the freezer based on the received instruction. The lock may be configured to process this instruction and unlock the door based on the instruction. Unlocking the door may comprise the lock causing the locking mechanism to disengage the door.

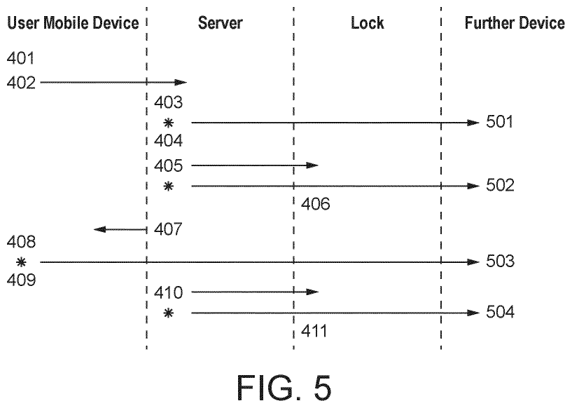

FIG. 5 schematically illustrates a method 500, which is a modified version of the method 400, where method 500 involves the generation of notifications/alerts to a further device different from the mobile device of the user. In this way, the security of the freezer/freezer and the integrity of the purchase can be increased in an efficient manner. The steps of method 400 are repeated in FIG. 5 and refer to the same features, and so discussion of these will not be repeated. Instead, the additional steps will now be discussed, which relate to when notifications may be generated and sent.

At 501, once the freezer has been identified, the server may generate and send a notification to a further device. The notification may comprise information indicating that the freezer has been identified. In some examples, the server may determine that the further device is proximal to the freezer and/or the device, and then send the notification to the further device.

In this way, when the further device is operated by a member of staff of an establishment in which the freezer is located, the member of staff may be notified that a user may be about to start a transaction with the freezer. Accordingly, the member of staff may choose to observe the transaction, thereby increasing the security of the freezer and transaction in an efficient manner.

At 502, once the server has generated and sent an instruction to the lock to cause the lock to unlock the freezer, the server may generate and send a notification to the further device. This notification may comprise information indicating that the freezer has been unlocked.

Thus, in the member of staff example, the member of staff is notified that that the freezer is now unlocked, and that user will be interacting with the freezer. This notification acts as an alert for the member of staff, who may then choose to observe the interaction of the user with the unlocked freezer. In this way, the security of the freezer is increased and the integrity of the transaction is increased.

At 503, once a digital image of the barcode of a frozen food product has been obtained, the user mobile device or the server may generate and send a notification to the further device. This notification may comprise information indicating that a frozen food product has been selected. In some examples, this notification comprises information indicating the frozen food product identified by the barcode, and/or the number of frozen food products scanned by the user. For example, the notification may comprise one or more digital images representative of the scanned frozen food products.

Thus, in the member of staff example, the member of staff is notified that a product has been scanned, and in some cases may be able to easily identify the product that has been selected and/or the number of products selected. This may enable the member of staff to easily determine whether the user is acting fraudulently. In particular, the need for complex sensing circuitry, for example cameras to detect that the user has selected the items they actually purchased, is reduced. This leads to a more cost-effective and efficient solution. These advantages are further enhanced in examples where standard freezers and electronic locks are utilised, as the present techniques increase the security of the freezer and the integrity of the transaction.

At 504, once the server has generated and sent an instruction to the lock to lock the freezer, the server may generate and send a notification to the further device. This notification may comprise information indicating that the freezer has been locked. In this way, the user of the further device, for example the member of staff, is kept up to date with the status of the freezer, and in particular the access to the freezer.

It will be appreciated that any combination of the notifications described in FIG. 5 may be sent. It will further be appreciated that at any step in FIG. 4 a notification may be generated and sent to a further device, where the notification comprises information indicating the step that has been performed.

The invention is described with reference to the following numbered clauses.
Clause 1. A method for controlling a lockable freezer, wherein the freezer defines a volume accessible by a door of the freezer, and the freezer comprises an electronically controlled lock configured to be controlled to lock and unlock the door thereby preventing and granting access to the volume, the method comprising: determining that a device is proximal to the freezer; obtaining information associated with the freezer; receiving user input via the device based on the information associated with the freezer; determining whether a condition associated with the user input is satisfied; and based on determining that the condition is satisfied, controlling the lock of the freezer.
Clause 2. The method according to clause 1, wherein determining that the device is proximal to the freezer is based on determining a location of the device.
Clause 3. The method according to clause 1, wherein determining that the device is proximal to the freezer is based on receiving a user input.
Clause 4. The method of clause 3, wherein the user input is a user selection of the freezer from a plurality of freezers.
Clause 5. The method of clause 3, wherein the user input is a unique identifier of the freezer.
Clause 6. The method according to clause 1, wherein determining that a device is proximal to the freezer is based on obtaining a unique identifier of the freezer.
Clause 7. The method according to clause 6, wherein obtaining the unique identifier of the freezer comprises obtaining, with a camera of the device, a digital image of the unique identifier of the freezer.
Clause 8. The method of any preceding clause, wherein the method further comprises displaying the information associated with the freezer on the device.
Clause 9. The method of any preceding clause, wherein obtaining the information associated with the freezer comprises retrieving the information from a data store, wherein the information indicates one or more items contained within the volume of the freezer.
Clause 10. The method of clause 9, wherein the information further indicates one or more items not contained within the volume of the freezer, the method further comprising, responsive to a user input, providing information associated with a second freezer which contains the one more items not contained in the freezer.
Clause 11. The method of clause 10, wherein the information associated with the second freezer comprises a location of the second freezer.
Clause 12. The method of clause 9, wherein receiving user input based on the information associated with the freezer comprises receiving a selection of the one or more items contained within the volume of the freezer.
Clause 13. The method of clause 12, further comprising after receiving a selection of the one or more items contained within the volume of the freezer, updating the information based on the selection.
Clause 14. The method of clause 12, further comprising sending a notification to a further device, wherein the notification comprises information indicating the selection of the one or more items.
Clause 15. The method of clause 14, wherein the information indicating the selection comprises one or more digital images representing the one or more items.
Clause 16. The method of clause 14, wherein the information indicating the selection indicates the number of selected items.
Clause 17. The method of clause 13, further comprising generating an alert based on updating the information.
Clause 18. The method of clauses 1 to 17, wherein the condition associated with the user input is whether the selection has been received.
Clause 19. The method of clauses 1 to 17, wherein the condition associated with the user input is whether a payment has been verified.
Clause 20. The method of clauses 1 to 17, wherein the condition associated with the user input is whether the user has been successfully authenticated.
Clause 21. The method of any preceding clause, wherein controlling the lock of the freezer comprises sending an instruction to cause the lock of the freezer to unlock the door of the freezer.
Clause 22. The method of clause 21, wherein the method further comprises determining that a pre-determined time period starting from the sending of the instruction has elapsed, and based on determining that the pre-determined time period has elapsed, sending a second instruction to cause the lock of the freezer to lock the door of the freezer.
Clause 23. The method of any preceding clause, wherein the freezer is a chest freezer and the door is a slidable door.
Clause 24. The method of clause 23, wherein the slidable door comprises a first slidable door and a second slidable door, each defining respective portions of the volume accessible by the respective slidable door in use, wherein the lock is configured to be selectively controlled to selectively unlock the first slidable door or the second slidable door.
Clause 25. The method of clause 24, further comprising:
determining whether the selection of the one or more items corresponds to one or more items located within the portion of the volume accessible in use by the first slidable door or the second slidable door; based on determining that the one or more items are located within the portion of the volume accessible in use by the first slidable door, controlling the lock to selectively unlock the first slidable door; and based on determining that the one or more items are located within the portion of the volume accessible in use by the second slidable door, controlling the lock to selectively unlock the second slidable door.
Clause 26. The method of clause 9, wherein the freezer further comprises a weight sensor, the method further comprising determining whether a change in weight sensed by the weight sensor corresponds to the selection of the one or more items, and in response to determining that the change in weight does not correspond, generating an alert.
Clause 27. The method of clause 26, wherein the freezer is divided into a plurality of sections, each section comprising a weight sensor.
Clause 28. The method of clause 9, wherein the freezer further comprises a capacitive sensor, the method further comprising generating an alert based on information sensed by the capacitive sensor.
Clause 29. The method of clause 9, wherein one or more of the freezer and lock further comprises a magnetic sensor, the method further comprising generating an alert based on information sensed by the magnetic sensor.
Clause 30. The method of any of clauses 26 to 29, wherein generating the alert comprises emitting a sound or activating a light source.
Clause 31. The method of any of clauses 26 to 29, wherein the method further comprises sending the alert to a second device different from the device.
Clause 32. The method of any previous clause, further comprising sending a notification to a further device different from the device based on the user input.
Clause 33. The method of any previous clause, further comprising, in response to determining that the device is proximal to the freezer, sending an alert to the device indicating that the device is proximal to the freezer.
Clause 34. The method of clause 33, wherein the alert further indicates one or more other freezers.
Clause 35. The method of any previous claim, further comprising, in response to determining that the device is proximal to the freezer sending a notification to a further device different from the device based on the user input.
Clause 36. A system comprising one or more processors configured to perform the method of clauses 1 to 35.
Clause 37. A computer-readable medium comprising instructions which, when executed by a computer, cause the computer to perform the method of clauses 1 to 35.

The methods discussed above may be performed under control of a computer program executing on a computing device or computing devices, for example a system comprising one or more processors, for example the device, server and lock system of FIG. 4, or the device, server, lock, and further device system of FIG. 5. Hence, a computer program may comprise instructions for controlling a computing device or computing devices or system comprising one or more processors to perform any of the methods discussed above. The program can be comprised in a computer-readable medium. A computer readable medium may include non-transitory type medium such as physical storage media, for example storage discs and solid state devices. A computer readable medium may additionally or alternatively include transient media such as carrier signals and transmission media, which may for example occur to convey instructions between a number of separate computer systems, and/or between components within a single computer system.

The various embodiments described herein are presented only to assist in understanding and teaching the claimed features. It will be appreciated that features may be combined and steps in methods omitted or performed in a different order. These embodiments are provided as a representative sample of embodiments only, and are not exhaustive and/or exclusive. It is to be understood that advantages, embodiments, examples, functions, features, structures, and/or other aspects described herein are not to be considered limitations on the disclosure scope defined by the claims or limitations on equivalents to the claims, and that other embodiments may be utilised and modifications may be made without departing from the scope of the invention as defined by the claims.

1. A method for dispensing one or more frozen food products from a lockable top-opening freezer, wherein the freezer defines a volume accessible by a door of the freezer, the volume contains the one or more frozen food products, and the freezer comprises an electronically controlled lock configured to be controlled to lock and unlock the door thereby preventing and granting access to the volume and the one or more frozen food products, the method comprising:
identifying the freezer with a user mobile device;
communicating with the electronically controlled lock to unlock the door of the freezer;
identifying on the user mobile device the one or more frozen food products and initiating a payment process; and
optionally communicating with the electronically controlled lock to lock the door of the freezer.

2. The method according to claim 1, wherein identifying the freezer with the user mobile device is based on receiving user input indicating an identifier of the freezer.

3. The method of claim 2, wherein receiving user input indicating the identifier of the freezer comprises receiving, from a camera of the user mobile device, a digital image of the identifier of the freezer.

4. The method of claim 2, wherein receiving the user input indicating the identifier of the freezer comprises receiving, from an input device of the user mobile device, the identifier of the freezer.

5. The method of claim 1, wherein communicating with the electronically controlled lock to unlock the door of the freezer comprises generating and sending an instruction to the electronically controlled lock to cause the electronically controlled lock to unlock the door of the freezer.

6. The method of claim 1, wherein identifying on the user mobile device the one or more frozen food products comprises receiving, from the user mobile device, one or more identifiers of the one or more frozen food products.

7. The method of claim 6, wherein receiving, from the user mobile device, the one or more identifiers of the one or more frozen food products comprises receiving, from a camera of the user mobile device, one or more digital images of the one or more identifiers of the one or more frozen food products.

8. The method of claim 7, wherein the one or more identifiers of the one or more frozen food products are one or more barcodes.

9. The method of claim 1, wherein initiating the payment process comprises displaying, on the user mobile device, a payment portal for receiving user payment input associated with the one or more frozen food products.

10. The method of claim 1, further comprising determining that a pre-determined time period starting from the communicating with the electronically controlled lock to unlock the door of the freezer has elapsed, and based on determining that the pre-determined time period has elapsed, communicating with the electronically controlled lock to lock the door of the freezer.

11. The method of claim 1, wherein the top-opening freezer is a chest freezer, and the door is a slidable door.

12. The method of claim 11, wherein the slidable door comprises a first slidable door and a second slidable door, each defining respective portions of the volume accessible by the respective slidable door in use, wherein the lock is configured to be selectively controlled to selectively unlock the first slidable door and/or the second slidable door.

13. A hinged or sliding door chest freezer comprising a locking arrangement, wherein the locking arrangement comprises an electronically controlled lock granting access to the freezer, and the locking arrangement further comprising a mobile device, the locking arrangement and the chest freezer configured to operate a method comprising:
identifying the freezer with the mobile device;
communicating with the electronically controlled lock to unlock the door of the freezer;
identifying on the mobile device one or more frozen food products and initiating a payment process; and
optionally communicating with the electronically controlled lock to lock the door of the freezer.

14. A system comprising a mobile device and one or more processors configured to perform a method comprising:
identifying a freezer with the mobile device;
communicating with an electronically controlled lock to unlock a door of the freezer;
identifying on the mobile device one or more frozen food products and initiating a payment process; and
optionally communicating with the electronically controlled lock to lock the door of the freezer.

15. A computer-readable medium comprising instructions which, when executed by a computer and a mobile device, cause the computer to perform a method comprising:
identifying a freezer with the mobile device;
communicating with an electronically controlled lock to unlock a door of the freezer;
identifying on the mobile device one or more frozen food products and initiating a payment process; and
optionally communicating with the electronically controlled lock to lock the door of the freezer.
